(19) United States
(12) Patent Application Publication
(10) Pub. No.: US 2005/0187323 A1
(43) Pub. Date: Aug. 25, 2005

(54) Method for colouring fertilisers

(76) Inventors: Andreas Harz, Schwalbach (DE); Olaf Mueller, Koenigstein (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/510,086

(22) PCT Filed: Mar. 14, 2003
(86) PCT No.: PCT/EP03/02675

(30) Foreign Application Priority Data
Apr. 3, 2002 (DE) 10214591.1

(51) Int. Cl. C08L 1/00

(52) U.S. Cl. 524/358; 524/190

(57) ABSTRACT

The invention relates to a method for colouring fertilisers, characterised in that a pigment-preparation containing 5-60 wt.-% of at least one pigment, 40-95 wt.-% of a paraffin oil and/or vegetable oil, 0 10 wt.-% of a dispersing agent or dispersing agent mixture and 0-5 wt.-% usual additives is produced, each of the percentages being in relation to the total weight of the pigment preparation; the pigment-preparation is optionally diluted with paraffin oil and/or vegetable oil and the pigment preparation or the diluted pigment-preparation is applied to the fertiliser which is to be coloured.

The present invention relates to a method for coloring fertilizers with pigments.

Numerous colorants, colorant solutions or dispersions are known for the marking of fertilizers. Solvent colorants, dissolved in oil and added to the fertilizer, are frequently used. However, solvent colorants exhibit a poor light fastness and a weak color intensity. Their resistance to acids and alkalis is bad. There is a limit to the solubility of the colorant in oil, accompanied by a poor depth of color. In addition, an increased covering power would be desirable.

In WO 97/19030, fertilizer mixtures are colored with inorganic pigment powders comprising small amounts of an oil. The oil is used for the dedusting of the finely divided inorganic pigment powders.

It is an object of the present invention to provide a method for coloring fertilizers by which a strong color intensity, a high light fastness and a high covering power are achieved, which is free from ecotoxicological effects and which exhibits a high resistance to acids and alkalis in the application medium. In addition, the incorporation in the application medium should not be limited by solubility limits.

It has been found that, surprisingly, a pigment preparation of an organic or inorganic pigment in an oil to a high degree meets the demands made.

The present invention relates to a method for coloring fertilizers, which comprises the production of a pigment preparation comprising 5 to 60% by weight of at least one pigment, 40 to 95% by weight of a paraffin oil and/or vegetable oil, 0 to 10% by weight of a dispersant or dispersant mixture and 0 to 5% by weight of conventional additives, in each case based on the total weight of the pigment preparation, the optional dilution of the pigment preparation with paraffin oil and/or vegetable oil, and the application of the pigment preparation or diluted pigment preparation to the fertilizer to be colored.

In a preferred embodiment of the method according to the invention, use is made of a pigment preparation comprising 5 to 40% by weight of at least one organic pigment and 60 to 95% by weight of a paraffin oil and/or vegetable oil.

In a further embodiment of the method according to the invention, use is made of a pigment preparation comprising 10 to 60% by weight of at least one inorganic pigment and 40 to 90% by weight of a paraffin oil and/or vegetable oil.

Use is preferably made of a pigment preparation consisting of 10 to 35% by weight, in particular 15 to 25% by weight, of at least one organic pigment, 65 to 90% by weight, in particular 75 to 85% by weight, of a paraffin oil and/or vegetable oil, 0 to 10% by weight of a dispersant or dispersant mixture and 0 to 5% by weight of conventional additives.

Furthermore, use is preferably made of a pigment preparation consisting of 15 to 50% by weight, in particular 20 to 40% by weight, of an inorganic pigment, 50 to 85% by weight, in particular 60 to 80% by weight, of a paraffin oil and/or vegetable oil, 0 to 10% by weight of a dispersant or dispersant mixture and 0 to 5% by weight of conventional additives.

Examples of organic pigments within the meaning of the invention are monoazo pigments, diazo pigments, diazo condensation pigments, laked azo pigments, triphenylmethane pigments, thioindigo pigments, thiazine-indigo pigments, perylene pigments, perinone pigments, anthanthrone pigments, diketopyrrolopyrrole pigments, dioxazine pigments, quinacridone pigments, phthalocyanine pigments, isoindolinone pigments, isoindoline pigments, benzimidazolone pigments, naphthol pigments and quinophthalone pigments. Mention may be in particular be made of acidic to alkaline blacks from the group consisting of furnace blacks and gas blacks.

Examples of inorganic pigments within the meaning of the invention are white pigments, iron oxide pigments, iron blue pigments, chromium oxide pigments, ultramarine pigments, mixed phase pigments, sulfide/sulfide selenide pigments, carbonate pigments, chromate/chromate-molybdate pigments, complex salt pigments, silicate pigments, luster pigments or luminescent pigments.

The term “paraffin oil”, within the meaning of the present invention, is to be understood as a highly fluid mixture of saturated aliphatic hydrocarbons with a density between 0.82 and 0.89 g/ml and a dynamic viscosity (at 25° C.) between 25 and 80 mPs. Commercial paraffin oils, also known as white oils, suitable for the method according to the invention can still comprise up to 40% of aromatic hydrocarbons.

The term “vegetable oils”, within the meaning of the present invention, is to be understood as liquid commercial oils from oil seeds, such as, e.g., sunflower oil, olive oil, palm kernel oil, rapeseed oil and mixtures of such oils.

The term “fertilizer”, within the meaning of the present invention, is mainly to be understood as synthetic inorganic fertilizers, such as, e.g., nitrogen, phosphate, potassium, calcium and magnesium fertilizers, which can be mixed with organic fertilizers and/or trace elements.

Examples of fertilizers which can be colored according to the method according to the invention are: ammonium sulfate, ammonium nitrate, calcium ammonium nitrate, urea, urea-aldehyde condensates, magnesium ammonium sulfate, ammonium sulfate nitrate, calcium nitrate, calcium cyanamide, superphosphate, double superphosphate, triple superphosphate, ground basic slag, dicalcium phosphate, potassium chloride, potassium sulfate, potassium magnesium sulfate, calcium carbonate, calcium oxide and mixtures thereof. The abovementioned fertilizers can also be coated with organic polymers or sulfur.

Anionic, cationic and nonionic surface-active compounds are suitable as dispersants. Dispersants having one or more medium- or long-chain hydrocarbon chains have proven to be particularly suitable. Only a fraction of the multitude of compounds are intended to be listed at this point, without, however, limiting the applicability of the compounds according to the invention to these examples.

Examples are alkyl sulfates, alkylsulfonates, alkyl phosphates, alkylbenzenesulfonates, such as lauryl sulfate, stearyl sulfate, dodecylsulfonates, octadecyl sulfates or dodecylsulfonates, condensation products of fatty acids and taurine or hydroxyethanesulfonic acid, alkoxylation products of alkylphenols, castor oil rosin esters, fatty alcohols, fatty amines, fatty acids and fatty acid amides, reaction products of nonylphenol and relatively short-chain substituted alkylphenols, and their polymeric derivatives, e.g. formaldehyde condensation products, and polymeric compounds, such as, e.g., polyacrylates, and their alkoxylates.

Suitable conventional additives are emulsifiers, suspension agents, anticaking agents, wetting agents, preservatives, viscosity stabilizers and additives which influence the rheology. Use is particularly made, as anticaking agents, of those which prevent the fertilizer granules from caking together.

The pigment preparation used according to the invention can be prepared by dispersing the organic or inorganic pigment, in the form of a powder, flush paste, pressed cake or granular material, in the presence of the abovementioned oils and optionally dispersants and/or conventional additives. If dispersants and/or additives are added, these components are preferably first mixed with the oil, the pigment is stirred in and, depending on the particle hardness of the pigment used, dispersing is carried out using stirrers, dissolvers, rotor-stator mills, ball mills, stirred ball mills, such as sand mills and bead mills, high-speed mixers, kneading devices or high-performance bead mills. The pigment preparation obtained is optionally further diluted with the abovementioned oil. The diluting can, vary within wide limits, for example up to 1:100, depending on the color intensity desired.

For the coloring according to the invention of the fertilizer, the pigment preparation described above, optionally after diluting beforehand with the abovementioned oil, is appropriately applied to the fertilizer in an amount of 0.00001 to 0.10% by weight, preferably 0.001 to 0.015% by weight, in particular 0.005 to 0.01% by weight, based on the weight of the fertilizer to be colored. This can, for example, be carried out by spraying the pigment preparation using a suitable apparatus, such as, e.g., a spraying apparatus. The pigment preparation can, however, also be applied directly to the surface of the synthetic fertilizer.

The temperature of the oil and of the pigment preparation, both during dilution and during application, can be appropriately between 10 and 80° C.

The purpose of the use of the oil-comprising pigment preparation described is to obtain a markedly higher covering power, a higher light fastness, a higher color intensity, as well as ecological advantages in comparison with colorants (since these generally have to be indicated on the label), and a markedly better resistance to acids and alkalis. In addition, a direct incorporation in the final product is possible, it being possible to dispense with the dissolution process. The preparation of mixed colors is possible in the cold state, since liquid preparations are involved.

Oil-comprising pigment preparations can in principle also be used for the pigmenting of shoe polish, candles, wax crayons, modeling clay, cosmetics, paints, including latex paints, or emulsion paints, for printing inks, for example textile printing inks, flexographic printing inks or gravure printing inks, for wallpaper colors, for wood preservation systems, for viscose spin dyeing, for varnishes, for sausage skins, for seeds, for glass bottles, for coloring roofing tiles throughout their bodies, for glasses, for wood stains, for paper pulps, for colored pencil leads, felt-tip pens, artist's inks, paste for ballpoint pens, chalks, detergents, cleaning products or shoe care products, coloring of latex products or abrasives, and also for the coloring of plastics and high-molecular-weight materials, and also as colorants in electrophotographic toners and developers, such as, e.g., single- or two-component powder toners, magnetic toners, liquid toners, polymerization toners and also additional specialty toners, or as colorants in ink jet inks, especially those on a nonaqueous basis, hot melt inks and microemulsion inks.

### EXAMPLES

A white oil of the following specification was used in the following examples:

| | |
|---|---|
| Kinematic viscosity at 20° C.: | 32 mm²/s |
| Density at 20° C.: | 848 kg/m³ |
| Melting point: | −9° C. |
| Refractive index at 20° C.: | 1.466 |
| Hydrocarbon distribution: | Paraffinic 67% |
| | Aromatic 33% |

### Example 1

25 parts of C.I. Pigment Red 112 and 75 parts of white oil were milled at 30 to 40° C. using a bead mill (Drais) with 280 parts of zirconium oxide beads (d=1 mm) via several passes. The pigment preparation has a high color intensity with a very pure hue and proves to be highly flowable and also stable on storage, i.e. the test specimen remains highly flowable in spite of heat ageing at 50° C. for 5 weeks.

Additional examples for pigment preparations:
2) 27 parts of Pigment Yellow 13 and 73 parts of white oil
3) 10 parts of Pigment Yellow 154 and 90 parts of white oil
4) 20 parts of Pigment Red 53:1 and 80 parts of white oil
5) 17 parts of Pigment Red 57:1 and 83 parts of white oil
6) 50 parts of Pigment Red 101 and 50 parts of white oil
7) 24 parts of Pigment Red 112 and 1.5 parts of polyethylene wax and 74.5 parts of white oil
8) 15 parts of C.I. Pigment Blue 15 and 85 parts of white oil
9) 20 parts of Pigment Blue 15:1 and 80 parts of white oil
10) 20 parts of Pigment Green 7 and 80 parts of white oil
11) 20 parts of Pigment Black 7 and 80 parts of white oil
   The pigment preparations described in examples 1 to 11 were diluted 1:10 with white oil and were applied using a spraying apparatus to a commercial NPK synthetic fertilizer:

The amount sprayed varied between 1 and 1000 g of pigment preparation per tonne of fertilizer according to the color intensity desired.

1) A method for coloring a fertilizer comprising the steps of producing a pigment preparation comprising 5 to 60% by weight of at least one pigment, 40 to 95% by weight of a paraffin oil and/or vegetable oil, 0 to 10% by weight of a dispersant or dispersant mixture and 0 to 5% by weight of at least one conventional additive, in each case based on the total weight of the pigment preparation, and applying the pigment preparation to the fertilizer to be colored.

2) The method as claimed in claim 1, wherein the pigment preparation comprises 5 to 40% by weight of at least one organic pigment and 60 to 95% by weight of a paraffin oil and/or vegetable oil.

3) The method as claimed in claim 1, wherein the pigment preparation comprises 10 to 60% by weight of at least one inorganic pigment and 40 to 90% by weight of a paraffin oil and/or vegetable oil.

4) The method as claimed in claim 1, wherein the pigment is an organic pigment selected from the group consisting of monoazo pigments, diazo pigments, diazo condensation pigments, laked azo pigments, triphenylmethane pigments, thio indigo pigments, thiazine-indigo pigments, perylene pigments, perinone pigments, anthanthrone pigments, diketopyrrolopyrrole pigments, dioxazine pigments, quinacridone pigments, phthalocyanine pigments, isoindolinone pigments, isoindoline pigments, benzimidazolone pigments, naphthol pigments, quinophthalone pigments, furnace blacks and gas blacks.

5) The method as claimed claim 1, wherein the pigment is an inorganic pigment selected from the group consisting of white pigments, iron oxide pigments, iron blue pigments, chromium oxide pigments, ultramarine pigments, mixed phase pigments, sulfide/sulfide selenide pigments, carbonate pigments, chromate/chromate-molybdate pigments, complex salt pigments, silicate pigments, luster pigments and luminescent pigments.

6) The method as claimed in claim 1, wherein the fertilizer is a synthetic inorganic fertilizer selected from the group consisting of nitrogen, phosphate, potassium, calcium and magnesium fertilizers.

7) The method as claimed in at claim 1, wherein the at least one conventional additive is selected from the group consisting of a suspension agent, anticaking agent, wetting agent, preservative, viscosity stabilizer and additive for influencing the rheology.

8) The method as claimed in claim 1, wherein the pigment is in the form of a powder or granular material, and the producing step further comprises dispersing in the presence of the paraffin oil and/or vegetable oil and optionally of the dispersant or dispersant mixture and/or of the at least one conventional additive.

9) The method as claimed claim 1, wherein the applying step further comprises applying the fertilizer in an amount of 0.00001 to 0.10% by weight, based on the weight of the fertilizer to be colored.

10) The method as claimed in claim 9, wherein the applying step further comprises spraying the pigment preparation onto the surface of the fertilizer.

11) The method as claimed in claim 1, further comprising the step of diluting the pigment preparation with paraffin oil and/or vegetable oil before applying the pigment preparation to the fertilizer.

12) A colored fertilizer made in accordance with the method of claim 1.

13) A colored fertilizer made in accordance with the method of claim 11.
